(19) United States
(12) Patent Application Publication
(10) Pub. No.: US 2009/0219131 A1
(43) Pub. Date: Sep. 3, 2009

(54) System for tracking hand washing and other tasks

(76) Inventors: Michael H. Barnett, New York, NY (US); Coleman L. Munch, Lafayette, CA (US); Mitchell A. Adler, Irvington, NY (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 12/380,376

(22) Filed: Feb. 26, 2009

Related U.S. Application Data
(60) Provisional application No. 61/067,760, filed on Feb. 28, 2008.

(51) Int. Cl. G08B 29/00; G06K 9/00

(52) U.S. Cl. 340/5.2; 340/5.83

(57) ABSTRACT

The system is designed for use in a hospital for tracking hand washing and other medical care related tasks. It includes multiple disinfectant soap dispenser devices connected to a network server that provide confirmation that caregivers are in compliance with hospital rules regarding hand cleanliness and the performance of other patient maintenance or treatment procedures. The system individually identifies each disinfectant soap dispenser device, identifies the location of the device associated with each patient and identifies each authorized caregiver or unauthorized recorded person using the device. The device identifies its location, the identity of caregiver, the time and date of use of device, and same is recorded in a network server as part of patient records.

### CROSS-REFERENCE TO RELATED APPLICATIONS

Priority is claimed on Provisional Patent Application No. 61/067,760 filed Feb. 28, 08.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to a method and apparatus for tracking hand washing and other healthcare related tasks, and more particularly a system of tracking hand washing and other healthcare related tasks for use in a multi-patient health care facility such as a hospital, long term care facility or the like.

2. Description of Prior Art Including Information Disclosed Under 37 CFR 1.97 and 1.98

Hospital acquired infections have become a major concern in the health care industry. Such infections kill more Americans each year than AIDS, breast cancer and auto accidents combined. It is estimated that there are as many as 2,000,000 cases of hospital acquired infections per year. Aside from the patient suffering that results from these infections, the added hospitalization costs of treating the infections, averaging an estimated $15,275 per case, totals over $30 billion per year.

The issue of hospital acquired infections is well known within and outside the health care community and has been widely reported in the news media. Awareness of this problem has resulted in increased surveillance of hospitals and better reporting of critical infection cases. Liability insurance rates for hospitals have increased, as has medical malpractice litigation, as a consequence.

Studies have shown that hand cleaning before patient treatment is the single most important way to protect against the spread of hospital acquired infections. With this in mind, many hospitals have set up extensive regulations with respect to hand cleanliness, particularly requiring healthcare professions to wash their hands before each patient treatment. However, achieving compliance with these rules has proved difficult.

The present invention is designed to monitor compliance with hospital rules regarding hand cleanliness and other medical related procedures. It provides a solution to the hand washing compliance problem by requiring confirmation of the use of a “smart” finger activated disinfectant soap dispensing device located in the hospital room of each patient. Each device includes an embedded microcontroller and is in communication with a network server in the hospital computer center. Further, the system provides information to the healthcare professional through the device as to other tasks that are to be performed on or for the patient, such as rotating the patient in the bed, taking the temperature of the patient, administering a particular medication, etc. The device functions as a convenient way for the healthcare professional to report that the tasks have been completed. The system automatically records the event, when it was performed and the identity of the performing individual.

We are aware of U.S. Pat. No. 6,206,238 issued Mar. 27, 2001 to Ophardt relating to a fingerprint activated fluids mixer and dispenser. That device includes fingerprint reader and a control system that regulates the dispensing of the fluid. However, the Ophardt device is not capable of interacting with other devices to form a system or of tracking compliance with cleanliness rules or other procedures.

We are also aware of U.S. Pat. No. 6,883,563 issued Apr. 26, 2005 to Smith relating to an apparatus and method for monitoring the usage of a network of personal hand sanitizing dispensers. However, that system does not use a fingerprint reader for identification purposes and requires that each healthcare professional have a unique identifier containing authorization data that must be entered into the device by a keyboard entry or electronic card prior to activation. Further, the Smith device only vends cartridges containing the cleaning fluid. It is not designed to dispense a dose of cleaning fluid directly to the hands of the user.

The Smith device does collect some data with respect to its operation. It records data relating to the date and time a specific cartridge is issued and to whom, the date and time the specific cartridge is returned and by whom, and the number of cartridges dispensed in a given time. However, the Smith system does not have the capability of tracking anything other than the dispensing and return of the cartridges.

### BRIEF SUMMARY OF THE INVENTION

The present invention is a system designed for use in a hospital or other health care facility for tracking hand washing and other medical care related tasks. It includes multiple disinfectant soap dispenser devices providing confirmation that caregivers are in compliance with hospital rules regarding hand cleanliness and the performance of other patient maintenance or treatment procedures. The system individually identifies each disinfectant soap dispenser device, identifies the location of the device, the specific patient associated with the location of each device and identifies each authorized caregiver or unauthorized recorded person using the device and the date and time the device is used. That information is stored in a network server and entered into the database containing patient records.

It is therefore a prime object of the present invention to provide a system for tracking hand washing and other medical care related tasks in a medical facility such as a hospital.

It is another object of the present invention to provide a system for tracking hand washing and other medical care related tasks which includes a network of “smart” disinfectant dispensing devices, one of which is located in each patient room.

It is another object of the present invention to provide a system for tracking hand washing and other medical care related tasks in which the disinfectant dispensing devices are fingerprint activated.

It is another object of the present invention to provide a system for tracking hand washing and other medical care related tasks in which the disinfectant dispensing devices each include a local an embedded CPU/microprocessor.

It is another object of the present invention to provide a system for tracking hand washing and other medical care related tasks in which the disinfectant dispensing devices are connected to a network server.

It is another object of the present invention to provide a system for tracking hand washing and other medical care related tasks in which the network server is connected to the electronic medical records system of the hospital.

It is another object of the present invention to provide a system for tracking hand washing and other medical care related tasks in which the network server is connected to the electronic financial and patient demographics computer system of the hospital.

It is another object of the present invention to provide a system for tracking hand washing and other medical care related tasks in which the disinfectant dispensing devices are connected to the network server by wireless or hard wired communications links.

It is another object of the present invention to provide a system for tracking hand washing and other medical care related tasks in which the network server automatically records of use of the devices, the identity of the user and the time and date of use.

It is another object of the present invention to provide a system for tracking hand washing and other medical care related tasks in which the network server communicates with the devices to download information relating to specific tasks a registered identified user is to perform on or for the patient in the hospital room in which the device located.

The above objectives are achieved by the present invention, one aspect of which relates to a system for tracking hand washing and other tasks in a facility of the type having multiple locations. The system includes a device associated with each location. Each device includes a fingerprint reader, a liquid dispenser, a microcontroller including a memory for storing the location of the device, and means for driving the associated disinfectant dispenser. The device also includes means for displaying information relating to tasks to be performed by the authorized user at the device location and means for entering confirmation that a task has been completed

The facility has a network server and means for operably connecting the network server to each device. The network server includes a memory storing information about registered users, including their fingerprints. The network server includes means for determining whether a read fingerprint matches a stored fingerprint and a list of tasks to be performed by an authorized user at the location associated with the device. The memory also records confirmation from the device that a particular task has been completed, as well as the identity of the identified user and the time and date confirmation is entered.

The display means includes an LCD display operably connected to the microcontroller.

The means for entering confirmation includes a data entry means operably connected to the microcontroller.

The display means and the data entry means may include a touch screen.

The network server includes means for comparing the stored fingerprints and the read fingerprint to determine if the read fingerprint matches a stored fingerprint, indicating an authorized user.

The driving means includes a drive circuit connected between the dispenser and the microcontroller.

The device further includes a local memory connected to the microcontroller. That memory preferably takes the form of a non-volatile EEPROM.

The connecting means includes an Ethernet module connected to the microcontroller. The module is connected to the network server by an Ethernet Interface jack.

The connecting means may alternatively include a wireless communications link connected to the microcontroller.

The network server is connected to the electronic records system of the facility.

The network server may also be connected to the electronic financial records system of the facility, which may include a patient demographics memory.

The network server includes means for accessing the list of stored tasks for the identified user to perform on the patient at the device location and for forwarding same to the microcontroller for display by the device. One of those tasks may include hand washing, in which case, the dispenser drive circuit is caused to activate the dispenser associated with the device.

The microcontroller contains instructions as to how to use the system which can be displayed on the display means in response to the proper entry from the data entry means.

The authorized user may be a medical professional, such as a doctor, nurse, aid or other healthcare professional.

The system includes means for activating the dispenser to dispense disinfectant to an unauthorized user.

The device includes a controller unit situated in an enclosure. The dispenser may be situated in that enclosure or in a separate enclosure.

The fingerprint reader may be situated in the controller unit enclosure.

In accordance with another object of the present invention, a method is provided for tracking hand washing and other tasks in a facility having multiple locations. The method is performed by a system that includes multiple devices connected to a network server. Each device has a microcontroller, data entry means and a display. A fingerprint reader and a disinfectant dispenser are associated with each device.

The method includes the following steps: registering individuals as authorized users by storing their identification information and fingerprints in the network server; and registering patients by storing patient information and location in the network server. Devices are registered by storing the device location in network server upon installation of the device.

After the registrations are completed, the device reads a fingerprint scanned on the fingerprint reader and forwards same to the network server. The network server compares the forwarded fingerprint with the stored fingerprints to determine if a match is present and if so, sends a message to device indicating an authorized user. It stores the user identification, location and time in memory. It then sends a message to the device causing the liquid dispenser associated with device to be activated to dispense a dose of liquid. The activation of dispenser, the location of associated device and time of activation is recorded in the network server.

The network server then determines the class of the authorized user and a task to be performed at the device location by a registered user in the determined class. It sends a message to the device indicating the determined task. The device then displays the task message on device display. The network server determines if confirmation of task completion has been entered on device. If so, confirmation of task completion is recorded in the network server.

The step of registering individuals as authorized users includes the steps of entering the fingerprint of the individual in the network server through a fingerprint reader connected to the server and entering information regarding the professional qualifications of the individual in the network server.

The step of sending a message from the network server to the device indicating the determined task includes the steps of having the authorized user swiping his or her finger a second time at the fingerprint reader of the same device and determining again if the individual is authorized.

The method further includes the steps of comparing the read fingerprint with fingerprints entered into the network server to determine if a match is present. If it is not present, a message is displayed on the device display asking if the unknown user wants liquid from the dispenser. If confirmation that the unknown user wants liquid is received within a given time period, the dispenser is activated.

### BRIEF DESCRIPTION OF THE SEVERAL VIEWS OF DRAWINGS

To these and to such other objects that may hereinafter appear, the present invention relates to a system for tracking hand washing and other tasks as described in detail in the following specification and recited in the annexed claims, taken together with the accompanying drawings, in which like numerals refer to like parts and in which:

FIG. 1 is a perspective view of nurse in a ward environment showing the dispensing device of the present invention mounted on a wall in a patient's room;

FIG. 2 is a more detailed perspective view of the device of FIG. 1;

FIGS. 3 and 3a illustrate the internal components of the liquid dispenser of FIG. 2;

FIG. 4 is a block diagram of the components of the preferred embodiment of the present invention;

FIG. 5 is a more detailed block diagram of the preferred embodiment of the present invention;

FIG. 6 is a block diagram showing the network layout of the system of the present invention;

FIG. 7 is a flow chart illustrating the user registration process;

FIG. 8 is a flow chart illustrating the patient registration process;

FIGS. 9A and 9B together form a flow chart illustrating the server application process;

FIG. 10 is a flow chart illustrating the device application process;

FIG. 11 is a flow chart illustrating the process when the identified individual is an authorized user;

FIG. 12 is a flow chart illustrating the process when the identified individual is not an authorized user; and

FIG. 13 is a flow chart illustrating a typical task algorithm.

### DETAILED DESCRIPTION OF THE INVENTION

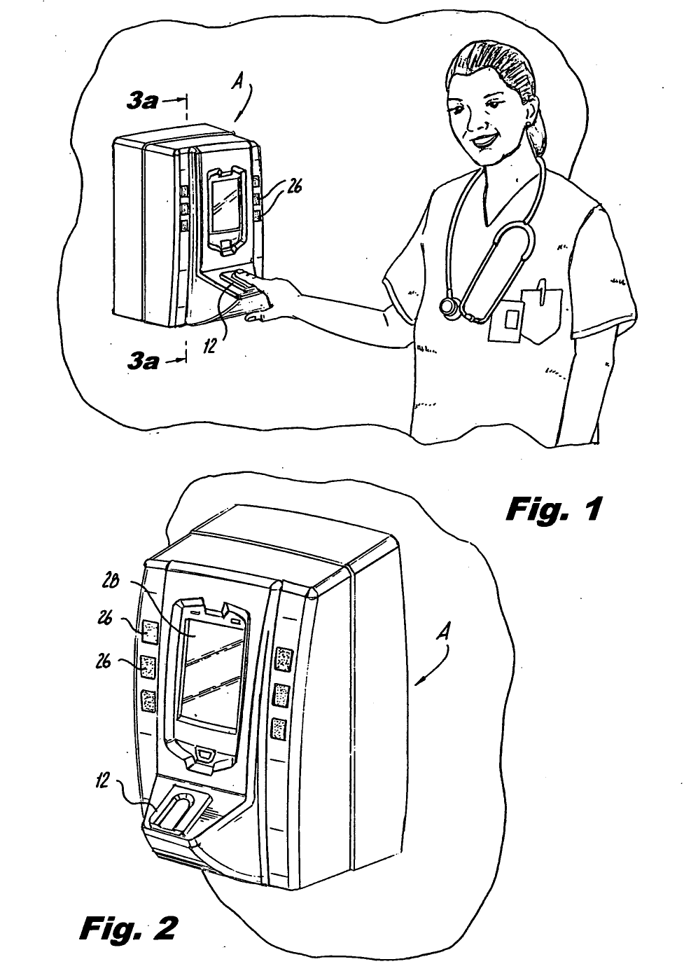

The invention relates to a system for tracking hand washing by individuals such as healthcare professionals as they tend to patients to avoid the spread of hospital-acquired infections and tracking the performance of other medical care related tasks, such as measures taken to periodically reposition patients to avoid or reduce ulcers in a hospital or other health care facility. The system includes a plurality of infection control devices, generally designated A, one of which is situated at each location in which a patient is present, such as a hospital room. The device is preferably situated on the wall adjacent the entrance of the hospital room as illustrated in FIG. 1 or beside the patient's bed. FIG. 1 shows a nurse in a hospital room operating one of the wall mounted devices A of the system.

Each device A includes a local CPU/microcontroller 10, a fingerprint reader 12 and a dispenser 14 for dispensing measured doses of a liquid, such as a disinfectant for hand washing. Components 10, 12 and 14 are preferably housed together as a single control unit 15 in one enclosure, as illustrated in the drawings. However, in order to permit the use of commercially available liquid dispensers, the CPU/microcontroller 10 and the fingerprint reader 12 may be situated in a one enclosure and the liquid dispenser 14 be situated in a separate enclosure. Whether dispensing device A consists of a single unit or two separate units, the device is preferably mounted to the wall of the hospital room proximate the patient associated with the device. This is illustrated in FIG. 1.

Data from control unit 15 of device A is downloadable (via infrared or direct link) from CPU/microcontroller 10 to a portable date collection device, such as a PDA, which can be carried by the healthcare professional.

For purposes of this disclosure, the word “device” will be used to refer to the control unit and the dispenser unit collectively, whether those units are housed in a single enclosure or in separate enclosures.

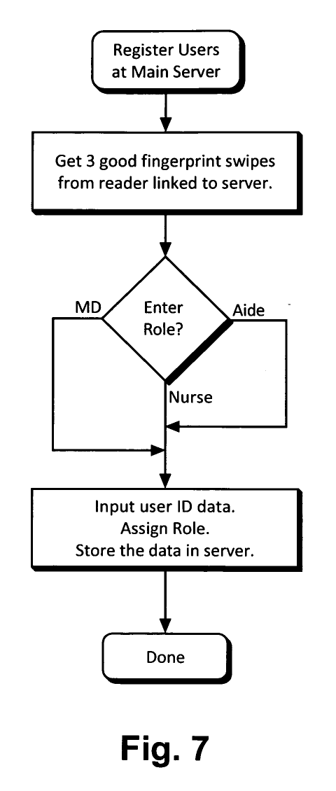

As illustrated in FIG. 6, each device A in the system is connected to a central data processing location in the hospital where a network server, generally designated B, configured as part of the system of the present invention is situated. Preferably, network server B is connected to a preexisting electronic record keeping systems of the hospital including a server, generally designated C, which forms part of the electronic medical record keeping system of the hospital and a server, generally designated D, which forms part of the electronic financial record keeping system of the hospital, including the patient demographics database.

Dispenser 14 may dispense soap based or alcohol based disinfectant and is designed for use in all industries which require regulation of personal hygiene; particularly, food processing, food service and pharmaceuticals, as well as healthcare and long term care. However, for purposes of illustration, the system is described herein as it would be used in a hospital.

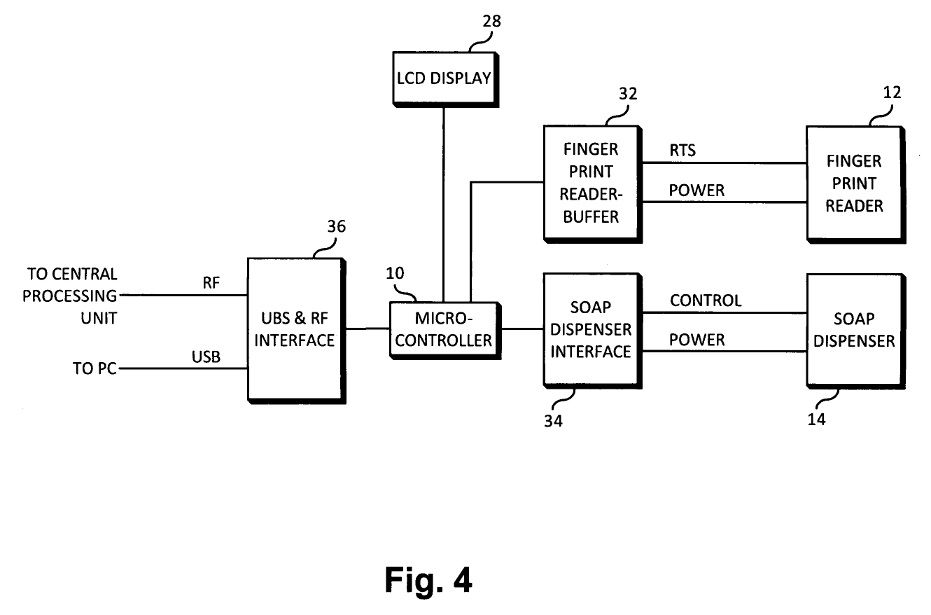

As illustrated in FIGS. 3 and 3a, dispenser device A includes an enclosure 16 with a front portion 17 (the inside of which is shown in FIG. 3) that can pivot to provide access to the internal components of the dispenser device. The enclosure contains a liquid storage cartridge or reservoir 18, an electromechanical mechanism 20 that regulates the release of fluid from cartridge 18, such as an electronically controlled servo valve, and an electronic control module 22, which controls mechanism 20 and is connected to CPU/microcontroller 10. Module 22 is connected to the network through CPU/microcontroller 10, or directly through port 24,

Fingerprint activation of the liquid dispenser allows date/time tracking for both the user and the location on the dispenser (such as in a patient hospital room, restaurant employee restroom or lettuce bagging area). The recorded data from the CPU is downloadable to a portable device, a networked server, or both.

In the hospital context, the primary focus for device A is to prompt and record measures taken by healthcare providers to avoid the spread of hospital-acquired infections and to eliminate or reduce pressure ulcers in acute care patients and long term care residents. The latter measures could, for example, include patient repositioning, observation of critical spots (heels and buttocks), placement of cushions and use of creams and moisture barrier products. There are many other tasks that could be preprogrammed, and facilities within which the system is installed would have the capability of programming network server B to add their own user-defined measures.

The system is not intended to replace medical records but to provide a convenient means of recording specific types of care provided. As with disinfectant dispenser 14, CPU/microcontroller 10 is activated via fingerprint reader 12 and its recorded data will be downloadable to either a portable device or a networked server. After download, data could be printed or digitally transferred to patient records to augment the primary patient care entries.

In addition to recording the care provided, the system is designed to be used to prompt/alert care providers when care is required/scheduled. Further, the device will provide a means to conveniently document compliance with skin care and decubitus ulcer standards. Although the focus is primarily on reducing the spread of hospital-acquired infections and avoiding pressure sores, the system could be used for any type of healthcare measure or procedure involving frequently repeated routines.

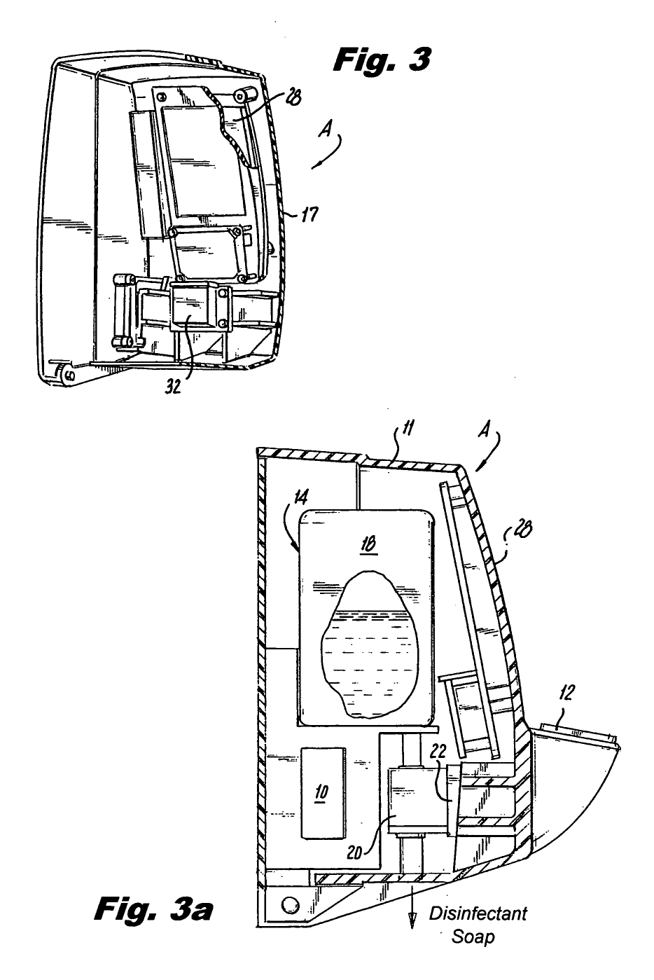

Hand washing and ulcer prevention are closely related in many instances, so the control unit 15, with its data entry keyboard 26 and monochromatic LCD display 28 (see FIG. 2), and the liquid dispenser 14 are complimentary and preferably linked together. When used in that manner, as in the preferred embodiment of the invention, both units are activated by a single fingerprint reader 12, and the dispenser data is integrated into the CPU/display record.

Further, keyboard 26 and display 28 may be combined into a single touch sensitive screen, as is well known in the art. Alternatively, keyboard 26 may also include “soft-keys” as seen in FIG. 2, the function of which is determined by the particular application, as is also well known in the art.

This technology will provide convenient data entry into the control unit by the healthcare professional at the location of the patient. The option of connecting a portable keyboard (as well as a PDA-type device for downloading) is particularly desirable for those applications where task checklists are to added and edited locally by the healthcare provider.

LCD screen 28 functions to display of instructions for the healthcare provider. It provides soft-key labels for the use of the keys in keyboard 26. It also displays a checklist of tasks to be performed on or for the patient associated with the location of the device.

Keyboard 26 can be formed of membrane, dome-switch, or conductive rubber buttons. Button functions include, but are not limited to, user operation and task confirmation.

Preferably, each device A is connected to server B by optionally selectable wireless or wired network connectivity.

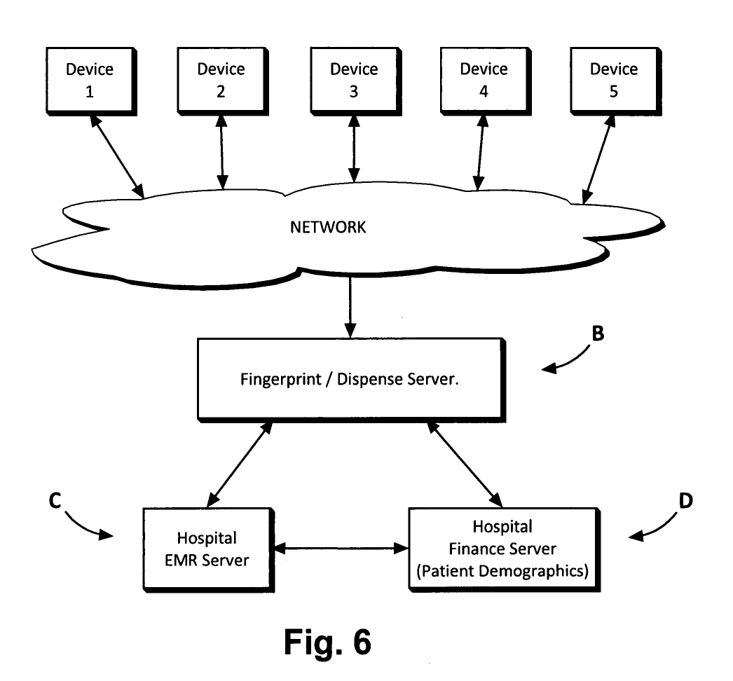

An external Class 2 power supply 30 (see FIG. 5) is associated with each device. Power supply 30 provides power to energize the device. No internal AC power conversion is required.

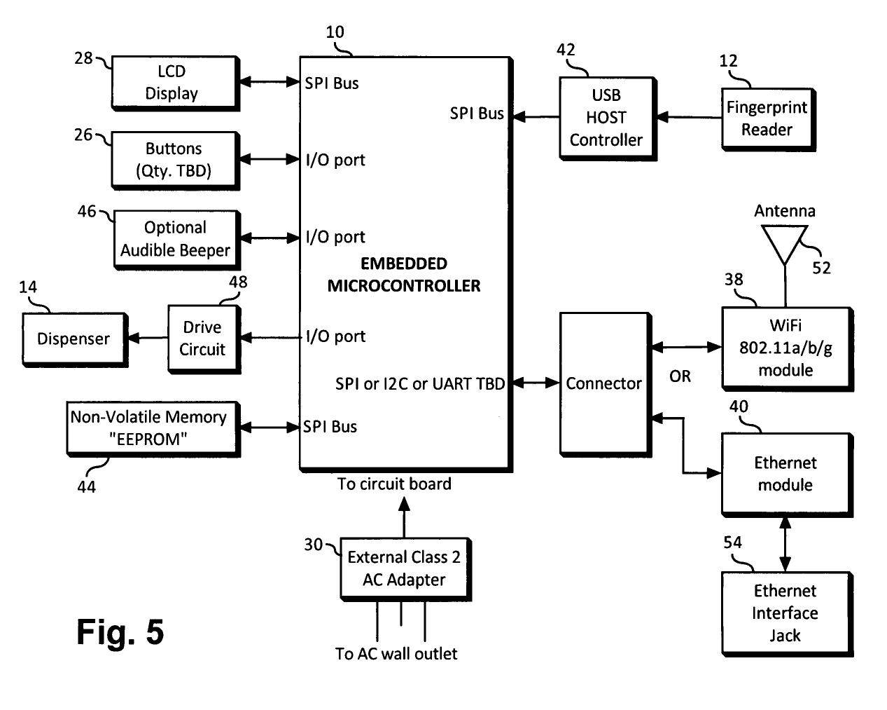

Further, the CPU/microcontroller in each device is provided with all of the necessary associated peripherals (i.e. memory, device interfaces, etc.) FIG. 4 illustrates the layout of the basic components of the preferred embodiment of device A, including the CPU/microcontroller 10 and fingerprint reader 12 of control unit 15, and a separate soap dispenser 14. As shown on this figure, CPU/microcontroller 10 is connected to fingerprint reader 12 through buffer 32 which provides power to the fingerprint reader and permits data communication between the CPU/microcontroller and the fingerprint reader. CPU/microcontroller 10 is connected to dispenser 14 through buffer 34 which provides power for the dispenser and provides control signals to module 22 in the dispenser to regulate the operation of the dispenser. CPU/microcontroller 10 is also connected to display 28.

CPU/microcontroller 10 is connectable to a PC (not shown) through a USB port and to remote network sever B via a radio frequency wireless connection, through USB and RF interface circuit 36.

Referring now to FIG. 5, which illustrates the device layout in greater detail, CPU/microcontroller 10 includes several Serial Peripheral Interface (SPI) buses, each of which forms a high speed serial electrical connection between the CPU/microcontroller and a different one of the peripheral devices, such as LCD display 28, memory 44 or network server B.

Alternately, CPU/microcontroller 10 may have a Inter-Integrated Circuit Interface (12C) bus which provides a high speed serial electrical connection between the CPU/microcontroller and a peripheral device, or a Universal Asynchronous Receiver Transmitter (UART) which provides a low speed serial connection traditionally used for communications between PC's and other terminating peripherals such as printers.

One of the SPI or I2C buses, or the UART, is used to connect the CPU/microcontroller and network server B wirelessly via a Wireless Fidelity (WiFi) module 38, also known as a 802.11 a/b/g module, (802.11 is an IEEE standard for high speed wireless local area network connectivity) or by wire via an Ethernet module 40 for connectivity to a high speed wired local area networks (LAN).

A Universal Serial Bus (UBS) host controller 42 provides a high speed serial connection between the CPU/microcontroller and fingerprint reader 12. One or more discrete input (I) or output (O) ports are associated with the CPU/microcontroller. The I/O bits that travel through those I/O ports are used to control or communicate with other hardware devices in a discrete fashion. When organized in groups of 8, the I/O ports may form a parallel bus for high speed communications.

Electrically Erasable Programmable Read Only Memory (EEPROM) 44 constitutes the local memory for the device. It is connected to the CPU/microcontroller. An EEPROM is a non-volatile memory device used to store system data or parameters and will retain the stored data even when power to the device is lost or disconnected CPU 10/microcontroller is preferably embedded into and forms a part of the integrated circuit board of the device. The CPU/microcontroller runs the device program referred to as “firmware”. This single chip contains all the necessary sub-units such as program store memory (FLASH ROM), RAM, inputs and outputs, serial ports, and other peripheral circuits required for complete control of the operation of the device.

Liquid crystal display 28 is implemented as a rectilinear display preferably approximately 3 to 4 inches wide. The pixel arrangement may be 128 by 128. The LCD provides the graphical user interface and displays items such as user information and instructions, display of tasks, and soft-key labels as required.

The device preferably includes several membrane, metal dome, or conductive rubber type buttons 26 arranged along one or more edges of the LCD screen 28 (see FIG. 2) such that labels indicative of the function of each of the buttons can be displayed near an associated button. These “soft-keys” are context sensitive in that the labels displayed on the LCD screen will change depending on the screen or process that is currently being presented to the user. For example, different tasks may be displayed for each button depending on the identified user.

An optional audible beeper circuit 46 may be included in the design to provide audible feedback to the user for specific actions. For example, a click can be provided when a button is pressed. Beeps or other tones can also be presented to indicate other actions, say incorrect responses or timeouts, etc.

The dispenser drive circuit 48 provides the necessary current to operate dispenser 14. Dispenser 14 is preferably an OEM sub-unit consisting of a housing which includes a replaceable container 18 that provides a source of liquid soap to be dispensed (see FIG. 3). The dispenser also consists of the necessary electronics, pump, and motor required to move the material from soap container 18 to a dispensing nozzle located at the bottom of the dispenser. We have found that the touchless dispensing modules commercially available from UltraClenz, LLC of Juniper, Fla. are well suited for this purpose.

The fingerprint reader 12 is also an OEM module that is integrated into the control unit enclosure. It is used to read the fingerprint pattern of a user. The user “swipes” a finger across the sensor pad 50 of the reader located on the exterior of the enclosure (see FIG. 2). The readings are collected and transferred to the CPU/microcontroller in the form of digital data.

Since the fingerprint reader presents the data via a USB interface, USB Host Controller 42 is required so the CPU/microcontroller can receive the data. While fingerprint sensors that transmit the data in other formats may also be considered for this application, we have found that the E3 intelligent embedded fingerprint reader module from Silex Technology America inc. of Salt Lake City, Utah works well in this application.

The WiFi (802.11 a/b/g) module 38 is an OEM module that provides wireless connectivity to a WiFi LAN that is implemented in the building or site in which the system is installed. It works in conjunction with antenna 52. This module is “pluggable” into the control unit so that Ethernet module 40 may be used instead, if wired connectivity is desired. It is also possible to use other types of wireless LAN protocols such as Zygbee.

Ethernet LAN module 40 is an OEM module that provides the wired connectivity to an Ethernet LAN that is implemented in the building or site in which the system is installed. This module is also “pluggable” so that a WiFi module may be used instead. Ethernet Interface jack 54 is provided to connect module 40 to the LAN.

Power for the device is provided by a standard “off-the-shelf” OEM manufactured, class 2, AC adapter 30.

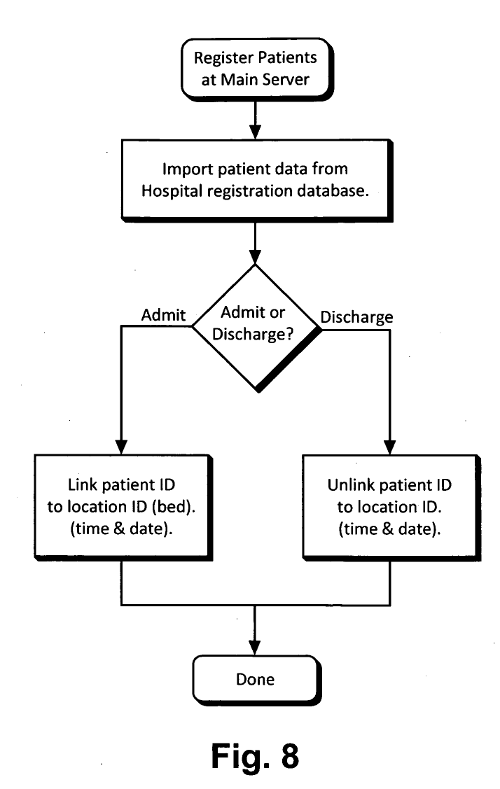

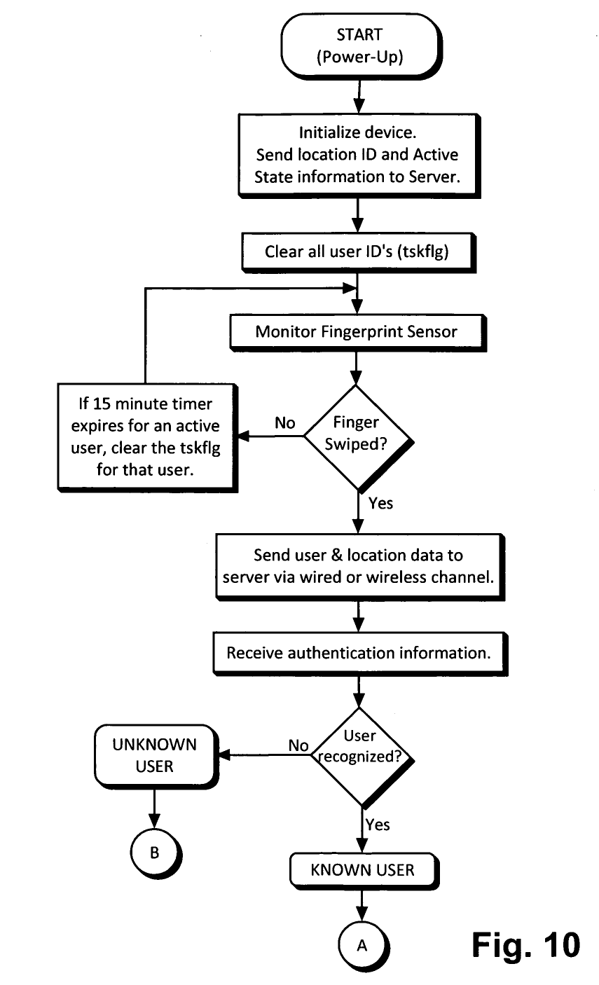

The step by step operation of the system is illustrated in the flowcharts of FIGS. 7 through 13 and described in the following text.

FIG. 7 illustrates the user registration process. As shown in that figure, users are registered into the network server B which is normally located at a central data processing location at the facility. A fingerprint reader similar to reader 12 is connected to the network server. The user swipes his or her finger along the sensor pad of that reader three times to insure a good quality print. A determination is made as to which class of healthcare providers the individual being registered falls into, for example, whether the registered user is a doctor, nurse or aid. That class information is entered into the network server using a keyboard or other data entry device. Additional identification data concerning the registered user, for example, the medical specialty of the doctor or the level of qualifications of the nurse, is also entered into the electronic file of the user.

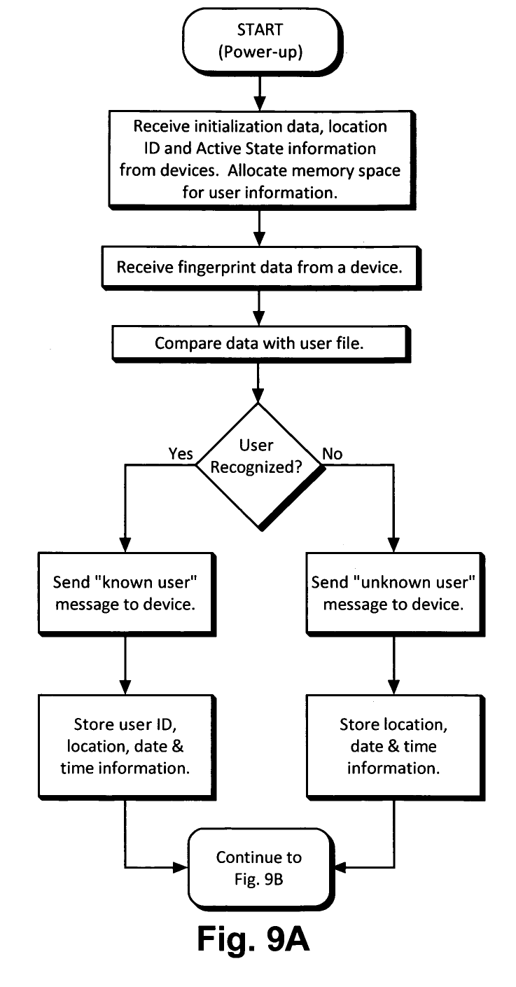

FIG. 8 illustrates the patient registration process. Incoming patients are also registered into the system through network server B. Patient data may imported from the hospital registration database of hospital server D or directly entered into the network server. If the patient is being admitted, the patent identification (ID) is linked to a particular location where one of the devices A is located, such as a particular hospital room to which the patient being registered is assigned. The time and date of the patient admittance is noted in the network server memory as well.

Devices A are associated with particular locations in the facility when those devices are installed in or removed from a hospital room.

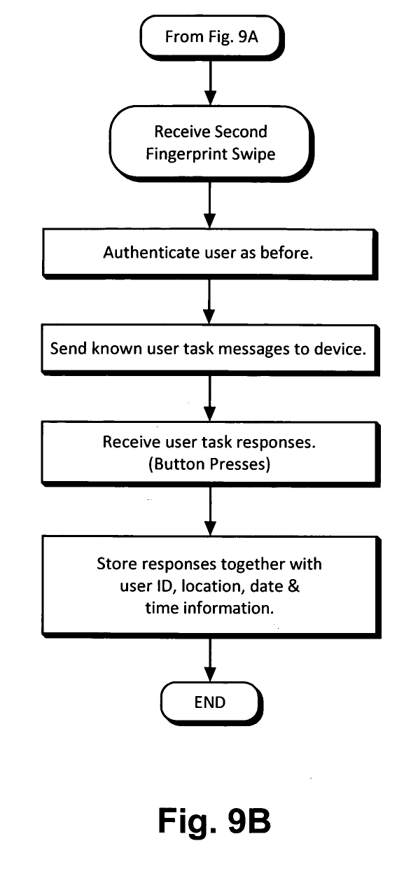

FIG. 9A illustrates part of the operation of the network server. Upon power up, the CPU/microcontroller 10 of each connected device in the system is initialized by clearing all the “tskflg” (task flag) memory locations and timers in the device. The device will then gain access to the network and sends its unit identification (location) information to the network server via the WiFi or Ethernet cards. In response, the server will “log on” the device as active, and associate the device with the location information stored in the server database. The date and time of the device log on is also recorded.

After initialization, the CPU/microcontroller in the device will continuously monitor the fingerprint reader of the device for data indicating that a user has swiped a finger. Once that occurs, the fingerprint data is forwarded to the network server via the network connection. The fingerprint data may be temporarily buffered in local RAM or transmitted in real time, depending on available system bandwidth and other parameters. The fingerprint data may be encrypted prior to transmission for security purposes.

The time, date and location of the device sending the fingerprint data is noted by the server upon receipt of the same. The server application software will then receive, analyze, and compare the read fingerprint data to previously stored fingerprint patterns recorded during the user registration process described above.

Upon completion of the comparison, the server will send authentication information back to the device that is associated with the transmitted fingerprint data. If the server application software identifies the pattern as a registered individual that is authorized to use the system, that is, a “known user”, a message indicating same is sent back to the device. Otherwise, an “unknown user” message is sent, indicating that the transmitted fingerprint data does not match any in the registered user database. The server will associate the time, date and location information with the analyzed fingerprint data for both known and unknown users and record the event in memory.

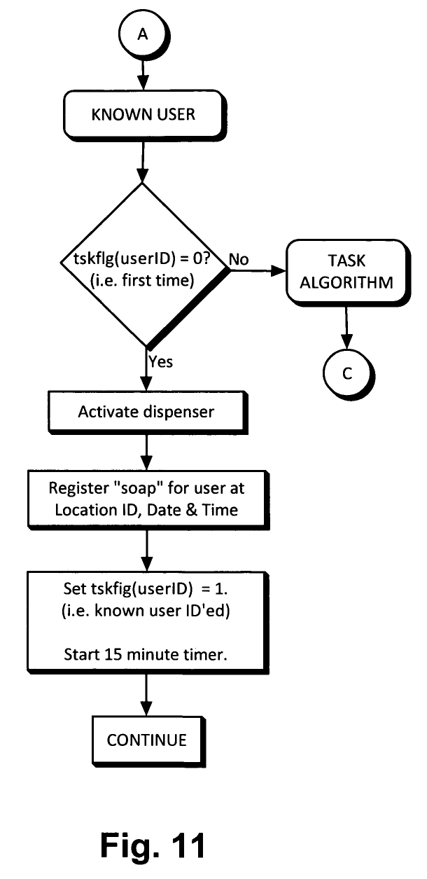

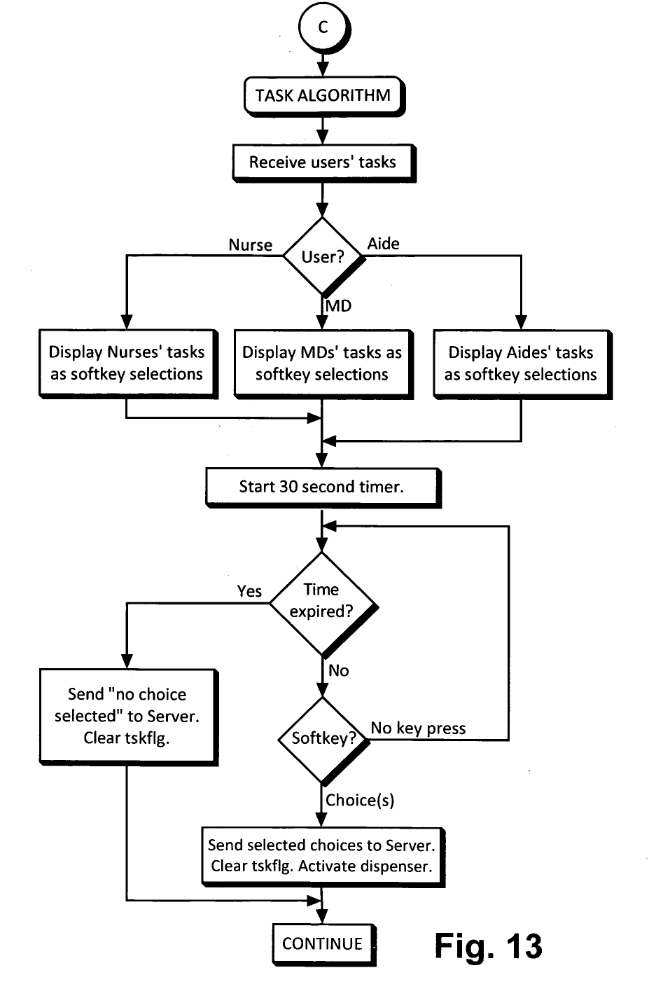

Referring now to FIG. 11, upon receipt of a “known user” message, the CPU/microcontroller of the device will check the “tskflg” indicative of the state of that particular user. If the flag is set to “1” indicating that the registered user has previously swiped his or her finger and received soap from the dispenser, the firmware branches to the “Task Algorithm” described below in connection with FIG. 13.

If the flag (tskflg) value is “0” indicative of a first swipe by the registered user, the CPU/microcontroller will selectively activate the dispenser mechanism to dispense a pre-determined amount of material, for example, one or more doses of liquid. The server then registers the date, time, and location of this event.

The CPU/microcontroller will then set the flag (tskflg) to “1” and start a 15 minute timeout timer. The CPU/microcontroller will continue to monitor the output of the fingerprint reader. If a second swipe by the same registered user is received within the time limit, the procedure described below in conjunction with FIG. 9B is followed.

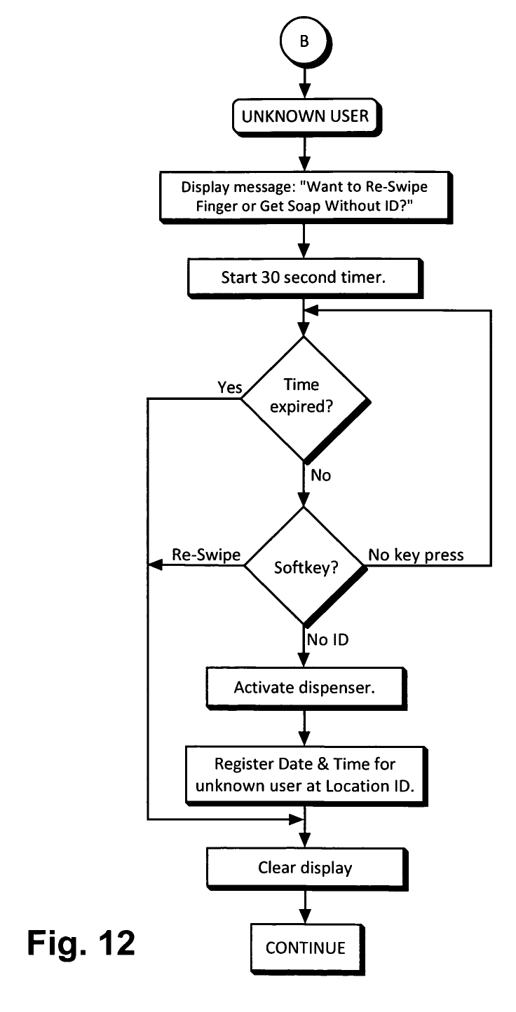

If, on the other hand, the device receives an “unknown user” message, meaning that the fingerprint read at the device does not match that of any registered user, the device proceeds through the steps set forth on the flowchart of FIG. 12. As illustrated in that figure, upon receipt of an “unknown user” message, the device will display one or more text messages on its LCD screen. For example, one message might be: “Want to Re-Swipe Your Finger or Get Soap without ID? The displayed message(s) may or may not be stored locally at in the memory of device. Variable messages may be stored at the network server and delivered to the device upon demand. Pre-determined, that is, unchanging, messages may be stored locally within the EEPROM 44 of device or in a program FLASH memory.

Soft-Key labels will also be displayed on the LCD screen for the above two choices, alongside associated buttons. These labels will indicate: “Re-Swipe” and “No ID” selections.

A 30 second timeout timer is started after the messages are displayed. The CPU/microcontroller will monitor and de-bounce the labeled buttons. It may also activate an audible feedback tone (i.e. click or beep) upon button depression.

If the unknown user depresses the “No ID” button, the device will dispense a dose of liquid, as described above. The network server will also record the time, date, and location information for this unknown user. The display is then cleared and the CPU/microcontroller will continue to monitor the fingerprint reader.

If the unknown user depresses the “Re-Swipe” button, the display will then be cleared and the CPU/microcontroller will continue to monitor the fingerprint reader.

If the 30 second timer expires before a button is pressed, the display will be cleared and the CPU/microcontroller will continue to monitor the fingerprint reader for another user.

Referring now to FIG. 9B which illustrates the steps taken after a known user has been identified and the dispenser has been activated. The known user will swipe his or her finger in the reader a second time. When data from the fingerprint reader relating to the second swipe of the fingerprint is received by the network server, the authentication process described above is repeated.

Assuming a registered user is again identified; user task messages are forwarded to the device from the network server and displayed. The registered user will then perform one or more of the displayed tasks and confirm the performance thereof by pressing the button on the device associated with the performed task. The network server will then record the response, along with the identification of the user, the location associated with the device and the time and date.

The algorithm by which the tasks are obtained, displayed and monitored is illustrated in FIG. 13. Upon a second finger swipe of an active user and transmission of data, the network server identifies one or more “tasks” associated with the identified registered user. For example, a user may be a doctor, a nurse, or an aide. Information relative to the user tasks of each class of healthcare professional has been previously entered and stored at the network server during the registration process. The network server will then send one or more messages to the device indicative of particular types of tasks that need to be performed by that class of user on or for the patient associated with the device location.

The CPU/microcontroller will display these tasks on the LCD screen. Each task requiring confirmation shall be associated with a button. Informational text messages may be displayed at any location on the LCD screen. The text messages may be stored locally or on the network server depending on system requirements.

After the tasks are displayed, the CPU/microcontroller will monitor the buttons as and start a 30 second timer. If within the given time period the user depresses one or more task buttons, device will send a message indicating the button depressions to the network server for confirmation and record keeping. The CPU/microcontroller will then activate the dispenser and continue to monitor the fingerprint reader for another user.

If the 30 second timer expires before any button is pressed, the CPU/microcontroller will send a message indicating “no choice selected” and the tskflg will be cleared for the user. The CPU/microcontroller then will continue to monitor the fingerprint reader for another user.

If any 15 minute timer expires before an active user swipes a finger the second time, that is before a task selection is made, the tskflg for that user is cleared and the user is made inactive. The CPU/microcontroller sends a message to the network server indicating this event and the CPU/microcontroller then continues to monitor the fingerprint reader as usual.

It will now be understood that the present invention is a system that dispenses disinfectant and confirms caregivers are in compliance with hospital rules regarding hand cleanliness and task performance.

Caregivers electronically record their fingerprints at a central location to register for the system. Since fingerprints are normally provided for background checks, fingerprint recording should not be problem. The fingerprints are recorded in a database containing information on all hospital caregivers. When a device is installed, it sends a code to the network server indicating its location. The server enters the room number where the device is situated and the name of the patient assigned to that room. Patient information is also registered.

Thereafter, caregivers must use the fingerprint pad on the control unit of a device to activate a dispenser to dispense soap. This information is sent to the network server where the identification of the caregiver, as well as the time and date of the event is recorded in the patient's records.

If a person who is not previously registered uses a device, that information is recorded in the network server as an unknown user.

Information may also be sent from the network server to the device providing task instructions or a checklist to be confirmed prior to or after device use.

If the user is registered, to request soap, the caregiver first moves a finger over the fingerprint reader. If the user is recognized as registered, an indicator appears on the display which confirms the user identity. Soap is then dispensed. Information regarding the event is transferred to the network server where it is recorded.

In response to a second swipe of the finger of a known user, the network server may send a message to the device providing instructions to the caregiver as to one or more tasks to be performed by the registered user at the location of the device. The caregiver presses a button on the device to confirm the instructions have been carried out. This is event is recorded in the server.

If a user who is not recorded as a registered user uses the device (such as a hospital visitor) the device will identify and record the user as unknown, and soap will be dispensed. Information will be sent to the network server recording the event, but defining the user as unknown.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

We claim:

1. A system for tracking hand washing and other tasks in a facility having multiple locations, the system comprising: a device associated with each location, each said device comprising a fingerprint reader, a liquid dispenser, means for driving said dispenser, a microcontroller including a memory for storing the location associated with the device, means for displaying a task to be performed by an authorized user at the stored location and means for a user to enter confirmation that the displayed task has been completed; and a network server operably connected to each said device comprising a memory containing information about authorized users, including their fingerprints, means for determining whether a read fingerprint matches a stored fingerprint and a task to be performed by a particular authorized user at the location associated with the device, means for recording confirmation entered on the device that the task has been completed, as well as the identity of the identified user and the time and date confirmation is entered.

2. The system of claim 1 wherein said displaying means includes an LCD display operably connected to said microcontroller.

3. The system of claim 1 wherein said means for entering confirmation includes a keypad operably connected to said microcontroller.

4. The system of claim 1 wherein said displaying means and the means for entering confirmation comprise a touch sensitive screen.

5. The system of claim 1 further comprising means for comparing the stored fingerprints and the read fingerprint to determine if the read fingerprint matches a stored fingerprint, indicating an authorized user.

6. The system of claim 1 wherein said driving means comprises a drive circuit connected between said dispenser and said microcontroller.

7. The system of claim 1 wherein memory comprises a non-volatile EEPROM.

8. The system of claim 1 further comprising means of connecting each of said devices with said network server.

9. The system of claim 8 wherein said connecting means comprises an Ethernet module connected between said microcontroller and said network server.

10. The system of claim 8 wherein said connecting means comprises wireless connecting means.

11. The system of claim 1 further comprising an electronic record keeping system operably connected to said network server.

12. The system of claim 1 further comprising an electronic financial record keeping system operably connected to said network server.

13. The system of claim 1 wherein said network server comprises means for accessing the list of stored tasks for an identified user to perform at the location associated with a device and means for forwarding same to said microcontroller for display by the device.

14. The system of claim 1 wherein said task comprises hand washing.

15. The system of claim 1 wherein said facility is a medical facility.

16. The system of claim 1 wherein said authorized user is a healthcare professional including a doctor, nurse, aid or other caregiver.

17. The system of claim 1 further comprising means for activating said dispenser to dispense disinfectant to an unauthorized user.

18. The system of claim 1 wherein said device comprises an enclosure comprising said fingerprint reader and said microcontroller.

19. The system of claim 18 further comprising a separate enclosure and wherein said dispenser is situated in said separate enclosure.

20. A method for tracking hand washing and other tasks in a facility having multiple locations performed by a system that includes multiple devices connected to a network server, each of which devices including a microcontroller, data entry means, a display, a fingerprint reader and a disinfectant dispenser, the method comprising the following steps:
(a) registering individuals as authorized users by entering their identification information and fingerprints in the network server;
(b) registering devices by entering information as to the location of the device in the network server upon installation at the location;
(c) reading the fingerprint of individual scanned on the fingerprint reader the device and forwarding same to the network server;
(d) comparing the read fingerprint with fingerprints entered into the network server to determine if a match is present and if so;
(e) storing the user identification, location and time at the network server;
(f) sending a message to microcontroller of the device to activate the dispenser associated with device; and
(g) recording the activation of dispenser, location of associated device and time of activation in the network server.

21. The method of claim 20 further comprising the steps of:
(h) determining the class of an authorized user;
(i) accessing the network server to identify a task to be performed by a authorized user of the determined class at the location associated with the device;
(j) sending a message from the network server to the device indicating the determined task;
(k) displaying the task message on device display;
(l) determining if confirmation of task completion is entered on device; and, if so,
(m) recording confirmation of task completion in the network server.

21. The method of claim 20 wherein the step of registering individuals comprises the steps of (n) entering the fingerprint of the individual in the network server through a fingerprint reader connected to the server and (o) entering information regarding the professional qualifications of the individual in the network server.

22. The method of claim 20 wherein the step of sending a message from the network server to the device indicating the determined task comprises the steps of: (p) the authorized user swiping his or her finger a second time at the fingerprint reader of the same device; (q) determining again if the individual is authorized; and repeating steps (i) through (m).

23. The method of claim 20 further comprising the steps of (r) comparing the read fingerprint with fingerprints entered into the network server to determine if a match is present and if not, (s) displaying a message on the device display asking if the unknown user wants liquid from the dispenser; (t) receiving confirmation that the unknown user want liquid within a given time period and (u) activating the dispenser.
